(19) United States
(12) Patent Application Publication
(10) Pub. No.: US 2014/0173487 A1
(43) Pub. Date: Jun. 19, 2014

(54) Method for Operating a Vehicle Information System, Vehicle Information System and Computer Program

(71) Applicant: Bayerische Motoren Werke Aktiengesellschaft, Muenchen (DE)

(72) Inventors: Jonathan CONRAD, Muenchen (DE); Wolfgang LENDERS, Ulm (DE); Thomas BENEDEK, Muenchen (DE)

(73) Assignee: Bayerische Motoren Werke Aktiengesellschaft, Muenchen (DE)

(21) Appl. No.: 14/188,409

(22) Filed: Feb. 24, 2014

Related U.S. Application Data
(63) Continuation of application No. PCT/EP2012/065428, filed on Aug. 7, 2012.

(30) Foreign Application Priority Data
Aug. 25, 2011 (DE) 10 2011 081 600.3

(51) Int. Cl. G06F 3/0484

(52) U.S. Cl. CPC G06F 3/0484
USPC 715/771

(57) ABSTRACT

A vehicle information system includes a user interface, a computer unit, and a communications interface designed for communicating with an external computer unit. An external application program that is allocated to the external computer unit is made available to a user of the vehicle by the user interface. An operator control instruction allocated to the external application program and in the form of a container with a discrete file system is made available to the computer unit. When the user retrieves, by way of the user interface, the operator control instruction, entry data contained in the container are signaled by the user interface. When a link that relates to a section of the operator control instruction of the specific external application program is retrieved, proceeding from the currently signaled operator control instruction of the external application program, the user searches only the data within the container that belong to the specific link by way of the user interface and once found these data are signaled by the user interface.

### CROSS REFERENCE TO RELATED APPLICATIONS

This application is a continuation of PCT International Application No. PCT/EP2012/065428, filed Aug. 7, 2012, which claims priority under 35 U.S.C. §119 from German Patent Application No. 10 2011 081 600.3, filed Aug. 25, 2011, the entire disclosures of which are herein expressly incorporated by reference.

### BACKGROUND AND SUMMARY OF THE INVENTION

The invention relates to a method for operating a vehicle information system, a vehicle information system, and a computer program.

Via a standard user interface, vehicle information systems increasingly integrate more comprehensive functionality, such as for instance radio, other audio sources such as for instance CDs, navigation aids, status information about the vehicle, and the like. Moreover, a variety of application programs, also known as apps, are available via external computer units, such as for instance an external mobile terminal device, which may be a smartphone, for instance. It is also desirable to make such apps available in the vehicle to the user of the vehicle information system, that is in particular to one of the occupants of the vehicle, by means of the user interface. Such apps are very dynamic; they undergo further refinement and new apps are constantly becoming available.

Known from DE 102009059140 A1 is a method for integrating a component into an information system of a motor vehicle in which at least one application that may be executed or that is provided using the component is made available to a user of the motor vehicle using a human-machine interface of the information system. When an application of the component connected to the information system starts, the application is assigned at least one priority for the human-machine interface. A priority provides a ranking with which the application of the component is handled with preference or subordinate to another application that is executed or is to be executed using the information. Preferably, when the application of the component starts, a message is transmitted to the information system in which the resources of the human-machine interface required by the application to execute it are described. A priority is assigned to one or each of a plurality of the resources of the human-machine interface required by the application.

The underlying object of the invention is to create a method for operating a vehicle information system, a vehicle information system, and a computer program that contributes to convenient and reliable operation of the vehicle information system.

The object is attained using a method for operating the vehicle information system, a vehicle information system embodied for its operation, and a computer program in accordance with the present invention.

In accordance with a first aspect, the invention is distinguished by a method for operating a vehicle information system that includes a user interface, a computer unit, and a communications interface which is designed to communicate with an external computer unit. The user interface is designed for communicating with a user of the vehicle information system, that is, in particular of a vehicle occupant. The user interface also has appropriate input and output units. Thus it may have optical and/or acoustic output units and it may for instance have acoustic and/or haptic input units. The external computer unit may, for example, be an external mobile terminal device, such as for instance a smartphone. However, it may also be any other external computer unit and thus, for instance, may also be a server in a communications network. It may also, for example, be a central computer, for instance of the vehicle manufacturer.

An external application program that is allocated to the external computer unit is made available to a user of the vehicle by way of the user interface. This may in particular include the user being able to retrieve and/or control the application by use of the user interface and, where applicable, the application program outputs via the user interface.

An operator control instruction allocated to the external application program and in the form of a container with a discrete file system is made available to the computer unit. When the user retrieves, via the user interface, the operator control instruction allocated to the external application program, entry data contained in the container are signaled by way of the user interface. When a link that relates to a section of the operator control instruction of the specific external application program is retrieved, proceeding from the currently signaled operator control instruction data of the specific external application program, the user searches only the data within the container allocated to the specific link by way of the user interface. Once found, these data are signaled by means of the user interface.

In this manner, in addition to the specific application program, the operator control instruction allocated thereto may be easily made available to the user by way of the user interface. In this context, it may also be provided that a diagrammed input and output functionality of the user interface, which is matched to the specific requirements in the vehicle environment, is also used for the operator control instruction for the specific external application program. Thus, a contribution is made to safety, even during vehicle operation, using the least possible claim on the attention of the driver and/or activation or deactivation of the interaction with the user that takes into account the driving situation. Moreover, more convenient operation of the specific external application program in the vehicle information system is facilitated by utilizing the information contained in the specific operator control instruction.

In this context, in particular by making available the operator control instruction allocated to the specific application program in the form of the container with its own file system, a contribution is made for providing very flexible integration into the vehicle information system, and specifically for instance even in cases in which files with the same file names are kept, such as for example those of other operator control instructions for other external application programs or even statically available application programs maintained internally in the vehicle information system. In this manner it is possible in particular to avoid ambiguities in following the links, which also includes the involvement of images.

In accordance with one advantageous embodiment of the first aspect, a specific identifier of entry data for the operator control instruction that is allocated to the specific external application program is embedded in a list in a prespecified sorting sequence. And, if an identical identifier is already present as an element of the list, a flag of the specific external application program is added to the specific identifier of the entry data. In this manner the specific identifiers of entry data for the operator control instruction that is allocated to the specific external application program may be unambiguously embedded in the list. Thus, when the list is represented by means of the user interface, it is possible to avoid ambiguities or multiple identical entries in the list.

In accordance with another advantageous embodiment of the first aspect, if the operator control instruction that is allocated to the specific external application program is not available in a prespecified language version, this is signaled by way of the user interface and specifically in a prespecified language. In this manner the user of the vehicle information system is able to easily understand that the specific operator control instruction is not available in the prespecified language version, since this information is signaled to him in the prespecified language, which may be his native language, for instance.

In this context it is advantageous when, if the operator control instruction that is allocated to the specific external application program is not available in the prespecified language version, the language version in which the operator control instruction is available is signaled by way of the user interface, and specifically in the prespecified language. A language version selection is offered to the user by way of the user interface and the operator control instruction is signaled in the specifically allocated language version regardless of the selection of a language version. In this manner it is possible for the user to easily select an alternative language version and then to be signaled the specific operator control instruction in the selected language version.

In accordance with another advantageous embodiment, a cache memory is allocated to the computer unit. After a connection has been established between the communications interface and the external computer unit, there is a test to determine whether the container of the operator control instruction allocated to the specific external application program is already stored in the cache memory. And, if so, the container stored there may be employed for making available the computer unit. If not, the container is stored in the cache memory when the communications interface provides the container. In this manner, when the specific container is present in the cache memory, the amount of data transmission required from the external computer unit to the vehicle information system may be kept low and the information associated with the specific operator control instruction may be made available to the user.

In accordance with a second aspect, the invention is distinguished by a vehicle information system that includes a user interface, a computer unit, and a communications interface that is designed for communicating with an external computer unit, the vehicle information system being embodied for performing the first aspect of the invention.

In accordance with a third aspect, a computer program is provided that includes computer program code suitable for executing the steps in accordance with the first aspect or its embodiments when the program is executed on the computer unit of the vehicle system.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic block diagram of a vehicle information system;

FIG. 2 is a block diagram of parts of the vehicle information system;

FIG. 3 is a first screen representation on the user interface; and,

FIG. 4 is a second screen representation on the user interface.

Elements having the same design or function are provided the same reference number in all of the figures.

### DETAILED DESCRIPTION OF THE DRAWINGS

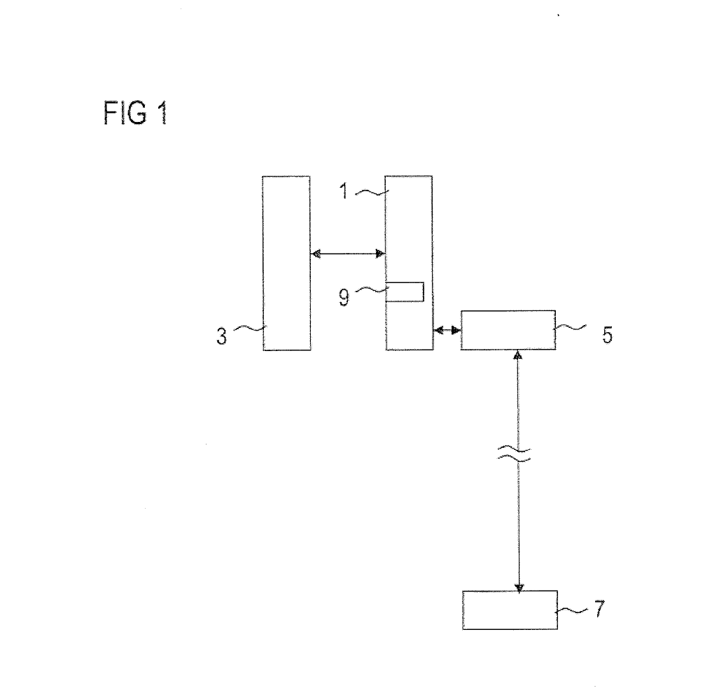

Referring to FIG. 1, a vehicle information system has a computer unit 1, a user interface 3, and a communications interface 5. The vehicle information system is, in particular, arranged stationary, that is, installed in a fixed manner, in the vehicle.

The user interface 3 is designed for communicating with a user, in particular with an occupant of a vehicle in which the vehicle information system is arranged. The user interface 3 includes one or a plurality of input units and output units. The output units may be designed and configured as optical and/or acoustic output units and thus include, for instance, a display screen. Moreover, the user interface 3 includes one or more input units that may be designed and configured as acoustic and/or manual input units. Thus, an input unit may be embodied for instance as a rotary adjuster, a touch-screen, and/or as a microphone.

The communications interface 5 is designed and configured for communicating with an external computer unit 7. The communications interface 5 may be designed as a communications interface 5 known for such purposes to anyone skilled in the art. It may also be embodied for wireless communication, and may include for instance a cell phone interface and/or a WLAN interface. However, it may alternatively or additionally also be designed for wired communication and may include for instance a USB interface. Communication with the external computer unit 7 may, moreover, be conducted interconnected with a communications network that may include for instance the Internet.

The external computer unit 7 may be, for instance, an external mobile terminal device, in particular a smartphone. However, it may also be, for instance, a server, such as a central computer that is operated for example by a vehicle manufacturer or the like.

The computer unit 1 includes at least one program, data storage and/or computing unit. The computer unit 1 executes programs that are stored in the data and/or program memory. The computer unit 1 optionally includes a cache memory 9. In the computer unit 1, signals are generated for signaling by way of the user interface 3. Also, signals that are generated by appropriate inputs at the user interface 3, are evaluated in the computer unit 1.

For instance, application programs (that may also be called internal application programs and that are stored for instance prior to initial operation of the vehicle in the data and/or program memory of the computer unit 1) may be stored in the data and/or program memory of the computer unit 1. These internal application programs may include for instance the functionality of a radio, such as in particular an FM radio. A specific operator control instruction that may also be called for instance an integrated operator control instruction (IOCI) is assigned to the specific internal application program.

Moreover, an external application program that is allocated to the external computer unit 7 may be made available to the user of the vehicle through the user interface 3. To this end, the specific external application program may be provided for instance at the communications interface 5 and thus may be transmitted as such from the external computer unit 7 to the vehicle information system. Preferably, the external application program is executed on the external computer unit 7, however, and only actions relating to inputs and outputs are performed by the vehicle information system.

Thus for instance the external computer unit 7 may function as a so-called application server or app server and make available to the user, as an external application program, a web radio and/or a communications service such as Twitter or the like, for instance by way of the user interface 3.

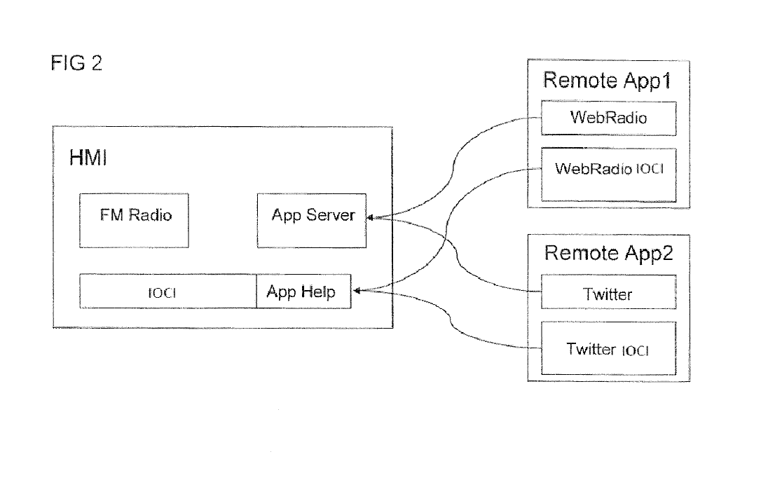

A block app server may thus include one or a plurality of external application programs of a specific external computer unit 7, as is depicted in FIG. 2. A corresponding block diagram representation may be signaled (displayed, for example) on the user interface 3 and for instance the blocks marked in FIG. 2 may be signaled as selection blocks. It is then possible to select these blocks by use of an appropriate input element, such as for instance with an input element having the functionality of a computer mouse.

Allocated to the specific internal application programs is an integrated operator control instruction IOCI that contains pertinent information about the specific internal application program and that may be retrieved by the user using a suitable selection.

An operator control instruction allocated to the specific external application program is made available in the form of a container, having a discrete file system, of the computer unit 1. This operator control instruction allocated to the specific external application program may in general be called, for example, App Help and thus may be for instance, in the case of a web radio as an external application program, a web radio integrated operator control instruction, WebRadio IOCI. In the case of an external application program that permits Twitter access, it may be, for instance, a Twitter integrated operator control instruction, Twitter IOCI.

The specific container is made available for instance together with the specific external application program being made available. The container may be made available for instance in the form of a zip file of the computer unit 1. To this end, the external computer unit 7 transmits the corresponding container to the communications interface 5 of the vehicle information system.

The computer unit 1 optionally has the cache memory 9 and, after a connection has been established between the communications interface 5 and the external computer unit 7, there is a test to determine whether the container of the operator control instruction allocated to the specific external application program is already stored in the cache memory 9. If so, the container stored there may be employed for making available the computer unit. If not, the specific container is stored in the cache memory 9 when the communications interface 5 provides the specific container.

When the user retrieves, via the user interface 3, the operator control instruction allocated to the specific external application program, entry data contained in the container are signaled by way of the user interface 3. When a link that relates to a section of the operator control instruction of the specific external application program is retrieved, proceeding from the currently signaled operator control instruction data of the external application program, the user searches only the data within the container allocated to the specific link by way of the user interface. Once found, these data are signaled by way of the user interface. Thus, for instance, a search always occurs only within the specific zip file.

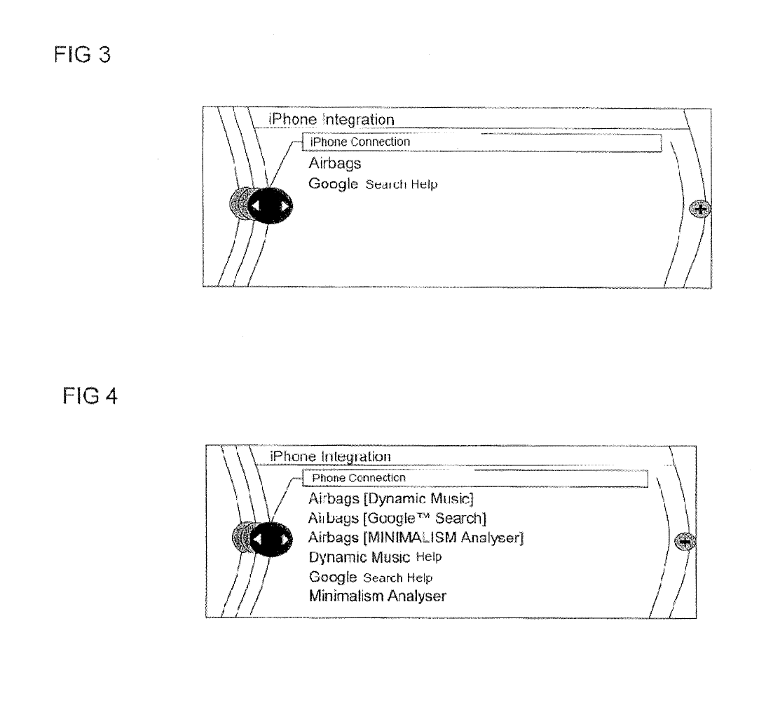

A first screen representation of the user interface 3 (FIG. 3) includes entries in a list with prespecified sorting and with different identifiers, such as “Airbags” and “Google Search Help.” After the external computer unit 7 has been coupled to the vehicle information system and thus the specific external applications program(s) that is/are allocated to the external computer unit 7 has/have been made available, specific identifiers of entry data of the operator control instruction that is allocated to the specific external application program are embedded in the list of the prespecified sorting, as is illustrated in the second screen representation of the user interface 3 in FIG. 4. The prespecified sorting may include, for instance, alphabetic sorting, but it may also be based on the history of how frequently the specific identifiers have been retrieved.

If an identical identifier that is already available is retrieved as an element of the list, such as the identifier “Airbags,” a flag for the specific external application program is added to the specific identifier of the entry data, such as for instance “[Dynamic Music]” or “[Google™ Search]” or “[MINIMALISM Analyzer]”.

If the operator control instruction that is allocated to the specific external application program is not available in a prespecified language version, this is signaled by way of the user interface, and specifically in a prespecified language. The language may preferably be prespecified in advance by the user and may be his native language, for instance. In this manner, it may be ensured in a simple manner that the user also simply understands the fact that the prespecified language version is not available for a specific external application program. The signal for this may be for instance in the following form: “The external application program is not available in German!”

Optionally, if the operator control instruction that is allocated to the specific external application program is not available in the prespecified language version, the language version(s) in which the operator control instruction is/are available may be signaled, and specifically may be signaled by way of the user interface 3 and specifically in a prespecified language. This prespecified language is thus quite likely to be easy for the specific user of the vehicle information system to understand. In this context, the user is offered a language version selection by way of the user interface 3 and, depending on the language version selected, the operator control instruction is signaled in the specific allocated language version. Thus, for instance, if the prespecified language is Chinese the user may be signaled in Chinese that the specific operator control instruction is only available in English, French, and German and the user then has the opportunity for instance to select English, which then subsequently leads to the specific operator control instruction being signaled in the English language version.

### REFERENCE NUMBERS

1 Vehicle information system
3 Computer unit
5 User interface
7 Communications interface
9 External computer unit

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of operating a vehicle information system having a user interface, a computer unit, and a communications interface operatively configured to communicate with an external computer unit, the method comprising the acts of:
making available to a user of the vehicle information system, via the user interface, an external application program allocated to the external computer unit;
making available to the computer unit an operator control instruction allocated to the external application program, the operator control instruction being in a form of a container with a discrete file system;
upon retrieval, via the user interface, of the operator control instruction allocated to the external application program, signaling, via the user interface, entry data contained in the container; and
upon retrieval of a link relating to a section of the operator control instruction of a specific external application program, proceeding from a currently signaled operator control instruction entry data of the external application program, searching, via the user interface, only data within the container that belongs to the link and, once said data is found, signaling said data via the user interface.

2. The method according to claim 1, wherein a specific identifier of the entry data for the operator control instruction allocated to the specific external application program is embedded in a list in a prespecified sorting sequence; and
if an identical identifier to the embedded specific identifier is already present as an element of the list, adding a flag of the specific external application program to the specific identifier of the entry data.

3. The method according to claim 1, further comprising the act of:
if the operator control instruction allocated to the specific external application program is not available in a prespecified language version, signaling in a prespecified language, via the user interface, that the operator control instruction is not available in the prespecified language version.

4. The method according to claim 3, further comprising the acts of:
if the operator control instruction is not available in the prespecified language version, offering a language version to the user, via the user interface; and
regardless of the offered language version, signaling the operator control instruction in the prespecificed language version.

5. The method according to claim 1, wherein the computer unit includes a cache memory, the method further comprising the acts of:
after a connection is established between the communication interface and the external computer unit, testing to determine whether the container of the operator control instruction allocated to the specific external application program is already stored in the cache memory; and
if the container is already stored in the cache memory, using the already stored container for making available the computer unit; and
if the container is not already stored, then storing the container in the cache memory when the communications interface is made available to the computer unit.

6. A vehicle information system operable with an external computer unit, the vehicle information system comprising:
a user interface;
a computer unit coupled with the user interface;
a communications interface coupled with the computer unit and being operatively configured to communicate with the external computer unit, wherein
an external application program allocated to the external computer unit is made available to a user of the vehicle information system via the user interface,
an operator control instruction allocated to the specific external application program is made available to the computer unit, the operator control instruction being in the form of a container with a discrete file system,
upon retrieval via the user interface of the operator control instruction allocated to the specific external application program, entry data contained in the container is signaled via the user interface, and
upon retrieving a link relating to a section of the operator control instruction, proceeding from the made available entry data, only searching the entry data within the container belonging to the specific link via the user interface, and once the entry data is found, signaling the entry data via the user interface.

7. A computer product of a vehicle information system having a user interface, a computer unit and a communications interface operatively configured to communicate with an external computer unit, the computer product comprising a computer readable medium having program code segments stored thereon for execution by the computer unit that:
make available to a user of the vehicle information system, via the user interface, an external application program allocated to the external computer unit;
make available to the computer unit an operator control instruction allocated to the external application program, the operator control instruction being in a form of a container with a discrete file system;
upon retrieval, via the user interface, of the operator control instruction allocated to the external application program, signal, via the user interface, entry data contained in the container; and
upon retrieval of a link relating to a section of the operator control instruction of a specific external application program, proceeding from a currently signaled operator control instruction entry data of the external application program, search, via the user interface, only data within the container that belongs to the link and, once said data is found, signaling said data via the user interface.
